(19) United States
(12) Patent Application Publication
(10) Pub. No.: US 2026/0128678 A1
(43) Pub. Date: May 7, 2026

(54) CONTROL CIRCUIT FOR A QUASI-RESONANT CONVERTER, RELATED INTEGRATED CIRCUIT, ELECTRONIC CONVERTER AND METHOD

(71) Applicant: STMicroelectronics International N.V., Geneva (CH)

(72) Inventors: Alfio PASQUA, Piedimonte Etneo (CT) (IT); Andrea RAPISARDA, Motta S. Anastasia (CT) (IT); Giovanni GRITTI, Bergamo (IT)

(73) Assignee: STMicroelectronics International N.V., Geneva (CH)

(21) Appl. No.: 19/377,623

(22) Filed: Nov. 3, 2025

(30) Foreign Application Priority Data
Nov. 4, 2024 (IT) 102024000024663

(51) Int. Cl. H02M 3/335; H02M 1/00; H02M 1/42; H02M 3/00

(52) U.S. Cl. CPC H02M 3/33507; H02M 1/0009; H02M 1/0058; H02M 1/4225; H02M 3/01

(57) ABSTRACT

A quasi-resonant electronic converter control circuit includes a regulator circuit generating a switch-off signal in response to an output feedback signal. A valley detection circuit generates a valley signal indicating detected valleys in a voltage at an electronic switch of the converter. A control circuit generates a switch-on signal as a function of the valley signal. A drive signal for the electronic switch is generated as a function of the switch-on signal and the switch-off signal. A valley selection circuit generates a valley selection signal indicative of a number of valleys. A timeout timer circuit determines whether a first time has lapsed with respect to a last instant of the valley signal and in response thereto a timeout timer circuit periodically generates pulses in a time-out signal repeated with a second time smaller than the first time. The switch-on signal is asserted when a valley count reaches the number.

### PRIORITY CLAIM

This application claims the priority benefit of Italian Application for Patent No. 102024000024663 filed on Nov. 4, 2024, the content of which is hereby incorporated by reference in its entirety to the maximum extent allowable by law.

### TECHNICAL FIELD

Embodiments of the present disclosure relate a control circuit for quasi-resonant electronic converter, such as a boost converter, such as a Power-Factor Corrector boost converter.

### BACKGROUND

Electronic converters, such as for example AC/DC or DC/DC switched mode power supplies, are well known in the art. There exist many types of electronic converters that may be divided mainly into isolated and non-isolated converters. For example, non-isolated electronic converters are converters of the buck, boost, buck-boost, Cuk, SEPIC, and ZETA types. Instead, isolated converters comprise a transformer, such as flyback and forward converters. These types of converters are well known to the person skilled in the art.

For example, FIG. 1 shows an example of the boost converter 20. In the example considered, the electronic converter 20 comprises a first and a second input terminal 200a and 200b for receiving a DC input voltage Vᵢₙ and a first and a second output terminal 202a and 202b for providing a DC output voltage Vₒᵤₜ. For example, the input voltage Vᵢₙ may be supplied by a DC voltage source, such as a battery. Generally, the DC input voltage Vᵢₙ may also be generated from an AC voltage via a rectifier circuit, such as a bridge rectifier. Conversely, the output voltage Vₒᵤₜ may be used to supply an electric load.

Specifically, in the example considered, the boost converter 20 comprises an inductance L and two electronic switches SW and D. The inductance L, such as an inductor, is connected (e.g., directly) between the positive terminal 200a and a switching node SN. The electronic switch SW, such as a Field-Effect Transistor (FET), such as a Metal-Oxide-Semiconductor Field-Effect Transistors (MOSFET), e.g., a n-channel FET, e.g., a NMOS, has a current path connected (e.g., directly) between the switching node SN and the negative terminal 200b. The further electronic switch D, such as a diode or a further FET, such as a p-channel FET, e.g., a PMOS, has a current path connected (e.g., directly) between the switching node SN and the positive terminal 202a, wherein the negative terminal 202b is connected to the negative terminal 200b. Often an output capacitor Cout is connected (e.g., directly) between the output terminals 202a and 202b, and/or an input capacitor Cin is connected (e.g., directly) between the input terminals 200a and 200b.

For example, such a boost converter 20 is often used as an electronic converter with Power Factor Correction (PFC) of a two-stage power supply. Specifically, in this case, the terminals 200a and 200b are connected via a rectifier circuit to two input terminals of the power supply, wherein these two input terminals are configured to receive an AC input voltage, such as 230 VAC with 50 Hz or 110 VAC with 60 Hz. Conversely, the terminals 202a and 202b are connected to the input terminals of a further electronic converter, which then supplies the load. For example, in case of a PFC boost converter, the converter 20 usually uses a small capacitance Cin between the terminals 200a and 200b in order to not influence significantly the power factor of the power supply. In fact, in a PFC boost converter 20, the voltage Vᵢₙ at the terminals 200a and 200b corresponds essentially to positive sinusoidal half-waves. Moreover, the output voltage Vₒᵤₜ is usually greater than the maximum value of the input voltage Vᵢₙ. For example, often the voltage Vₒᵤₜ is approximately 400 V.

The various modes of operation of a PFC boost converter are well known in the art. For example, in this context may be cited STMicroelectronics, Application note AN2761, “Solution for designing a transition mode PFC preregulator with the L6562A”, November 2009, Doc ID 14690 Rev 2 (incorporated herein by reference).

For example, in FIG. 1, the boost converter 20 comprises also a control circuit 210 configured to generate a drive signal DRV for the electronic switch SW and optionally the electronic switch D (if a controllable electronic switch is used). Substantially, as also shown in FIG. 2, in a quasi-resonant boost converter, the control circuit 210 is configured to drive the electronic switch SW and optionally the electronic switch D, in order to repeat switching cycles having a duration T_{SW} and comprising: a first time-interval T₁, where the electronic switch SW is closed and the electronic switch D is opened; a (following) second time-interval T₂, where the electronic switch SW is opened and the electronic switch D is closed; and a (following) third time-interval T₁, where the electronic switches SW and D are opened.

For example, the control circuit 210 may be configured to assert the drive signal DRV at an instant t₀ to close the electronic switch SW, de-assert the drive signal DRV at an instant t₁ to open the electronic switch SW, and assert the drive signal DRV again at an instant t₃ to close the electronic switch SW, where the instant t₃ corresponds to the instant t₀ of the next switching cycle T_{SW}. Accordingly, in the example considered, the drive signal DRV is asserted for a switch-on period T_{ON}=T₁ (between the instants to and t₁) and de-asserted for a switch-off period T_{OFF}=T₂+T₃ (between the instants t₁ and t₃).

Specifically, in the example considered, the time-interval T₂ ends at an instant t₂, when the current I_{L} reaches zero. For example, this is automatically obtained when the electronic switch D is a diode. Conversely, when the control circuit 210 also generates the drive signal for the electronic switch D, the control circuit 210 may monitor a signal indicative of the current I_{L} (at least) during the interval T₂, e.g., the current flowing through the inductance L or the electronic switch D. In this case, the control circuit 210 may assert the drive signal of the electronic switch D at the instant t₁ and, in response to determining that the current I_{L} reaches zero at an instant t₂, de-assert the drive signal of the electronic switch D. Accordingly, in the example considered, the electronic switch D is closed for the time interval T₂.

Accordingly, during the time-interval T₁, the inductance L is connected via the electronic switch SW to the input terminals 200a and 200b, i.e., the input voltage Vᵢₙ, and the current I_{L} flowing through the inductance L (which corresponds to the current flowing through the electronic switch SW) increases substantially linearly.

For example, in many boost converters, the duration of the interval T₁ is varied/modulated in order to obtain a requested output voltage Vₒᵤₜ (usually the case for a PFC converter) or output current iₒᵤₜ. For example, in FIG. 1 is shown a feedback circuit 212 configured to generate a feedback signal FB indicative of the output quantity to be regulated, i.e., the output voltage Vₒᵤₜ or the output current iₒᵤₜ. Accordingly, the control circuit 210 may be configured to vary the duration of the switch-on interval T_{ON}=T₁ until the output quantity corresponds to a requested value. Often the feedback signal FB is proportional to the output quantity to be regulated or corresponds already to an error signal.

For example, the control circuit 210 often varies directly the time T_{ON}=T₁ as a function of the feedback signal FB or uses a peak-current control (PCM). For example, when using PCM, the electronic converter 20 comprises a sensor circuit 214 configured to generate a signal CS indicative of (e.g., proportional to) the current I_{L} flowing through the inductance L during the interval T_{ON}=T₁. For example, the sensor circuit 214 may monitor the current flowing through the inductance I_{L} or the electronic switch SW. For example, the circuit 214 may be implemented with a resistor connected between the source of the switch SW and the terminal 200b. Accordingly, in this case, the control circuit 210 may be configured to open the electronic switch SW at the instant t₁ when the signal CS indicates that the current I_{L} has reached a reference/peak value.

For example, in a PFC boost converter, the control circuit 210 may vary the reference/peak value in order to obtain approximately sinusoidal current consumptions during each half-cycle of the voltage Vᵢₙ, thereby synchronizing the current consumption with waveform of the voltage Vᵢₙ.

Conversely, during the time-interval T₂, the inductance L is connected via the electronic switch D to the output terminals 202a and 202b and the current I_{L} flowing through the inductance L (which corresponds to the current flowing through the electronic switch D) decreases substantially linearly. Since the current I_{L} is positive during the time-interval T₂, the current is provided to the output terminals 202a and 200b and charges the output capacitance Cout.

In a quasi-resonant boost converter, the time-interval T₃ is used to close the electronic switch SW at an instant t₃, when the voltage V_{DS} at the electronic switch SW reaches a minimum value, thereby reducing switching losses of the electronic switch SW. In fact, in a real boost converter, the voltage V_{DS} at the electronic switch SW, e.g., between the drain and source terminals of a respective FET, comprises an oscillation, which derives from the resonant circuit comprising the inductance L and capacitances associated with the switching node SN. For example, in a typical boost converter 20, the oscillation has a period T_{R} corresponding to:

$${T}_{R} = 2 π \cdot \sqrt{L \cdot ( {C}_{OSS} + {C}_{d} )} \qquad ( 1 )$$

where C_{OSS} corresponds to the output capacitance of the electronic switch SW and Cd comprises further parasitic capacitances associated with the switching node SN, such as the capacitance of the electronic switch D and the inductance L.

For example, as shown in FIG. 1, usually the electronic converter 20 comprises a valley monitoring circuit 216 configured to generate a signal DMG indicative of the voltage V_{DS} at the electronic switch SW. In general, at least part of the valley monitoring circuit 216 may also be implemented in the control circuit 210.

For example, as shown in FIG. 3A, the valley monitoring circuit 216 may directly monitor the voltage V_{DS} of the electronic switch SW. For example, in FIG. 3A, the valley monitoring circuit 216 is implemented with a resistor R_{ZCD} connected to the switching node SN.

Conversely, in FIG. 3B, the valley monitoring circuit 216 monitors the demagnetization (DMG) of the inductance L, which implicitly indicates a valley in the voltage V_{DS}. For example, for this purpose, the inductance L may be implemented with a winding of a transformer also comprising an auxiliary winding Taux, wherein the voltage at the auxiliary winding Taux is provided to the control circuit 210, e.g., via a resistor R_{ZCD}.

In general, one or more of the following circuits may also be implemented together with the control circuit 210 in an integrated circuit: the electronic switch SW and/or the electronic switch D, at least part of the feedback circuit 212, at least part of the current measurement circuit 214, and/or at least part of the valley monitoring circuit 216.

Accordingly, the solution shown in FIG. 2 works close to the boundary between discontinuous (DCM) and continuous conduction (CCM) of the inductor L, with a mode of operation which is commonly called “valley switching.” The control circuit 210 may also be used with other electronic converters, which may be driven with the quasi-resonant/valley switching mode, such a buck, buck-boost or flyback converter.

A quasi-resonant converter has many advantages compared to a fixed frequency (PWM) operation, in particular the reduction of switching losses, because the switch SW is closed when the voltage across the switch SW reaches a minimum value. However, a quasi-resonant converter has also disadvantages, in particular deriving from the variable switching frequency, depending on the operative conditions. For example, the switching frequency f_{SW}=1/T_{SW} usually increases as the input voltage Vᵢₙ increases and/or the load decreases. This behavior may have a big impact in the converter switching losses.

As shown in FIG. 4, to overcome this issue, the control circuit 210 may be configured to not switch the switch SW at the first valley (t₃) but at one of the following valleys (t₃′, t₃″, etc.), thereby preventing that the switching frequency f_{SW} exceeds a given threshold value.

For example, FIG. 5 shows a common solution of a control/driver circuit 210 for a quasi-resonant converter. Specifically, the control circuit 210, such as an integrated circuit, comprises two terminals for receiving a supply voltage, such as a (positive) terminal VDD and a ground terminal GND, and a terminal for providing a drive signal DRV to an electronic (power) switch SW of the electronic converter, such as the gate terminal of a respective n-channel FET, e.g., a NMOS. As mentioned before, the electronic switch SW is usually configured to connect a resonant circuit of the electronic converter to the input terminals 200a and 200b of the electronic converter 20, and the control circuit 210 is configured to close the electronic switch SW at a valley point of the voltage at the electronic switch SW. In general, the control circuit 210 may also comprises further terminals for generating further drive signals, e.g., in case the resonant circuit is connected to the input terminals 200a and 200b via a half-bridge or full-bridge arrangement. Additionally, or alternatively, one or more switches may be used to connect the resonant circuit to the output terminals 202a and 202b of the electronic converter, e.g., in case the diode D (or a similar diode of a flyback, buck or buck-boost converter) is replaced with a controllable electronic switch. The electronic switch SW may also be included in the control circuit 210.

In order to implement the quasi-resonant switching, the control circuit 210 comprises terminals for monitoring the operation of the electronic converter.

Specifically, a first terminal is configured to receive a feedback signal FB from a feedback circuit 212, wherein the feedback signal FB is indicative of the output quantity to be regulated, e.g., the output voltage Vₒᵤₜ or the output current iₒᵤₜ provided via output terminals 202a and 202b of the electronic converter 20. In general, the feedback signal FB may also correspond directly to an error signal.

A second terminal is configured to receive a signal DMG from a valley monitoring circuit 216, wherein the signal DMG is indicative of the voltage V_{DS} at the electronic switch SW (at least) during the period T₃. For example, the valley monitoring circuit 216 may monitor directly the voltage V_{DS} at the electronic switch SW or may monitor the valley implicitly by determining a demagnetization of the inductance of the resonant circuit (as described with respect to FIGS. 3 and 4).

When the control circuit uses PCM, a third terminal is configured to receive a signal CS from a current measurement circuit (sensor) 214, wherein the signal CS is indicative of (e.g., proportional to) the current flowing through the electronic switch SW (at least) during the switch-on period T_{ON}. As mentioned before, during the switch-on period T_{ON} the signal CS is usually indicative of the current provided to the resonant circuit, such as the current flowing through an inductance of the resonant circuit, such as the current I_{L} flowing through the inductance L. In fact, this permits to implement the peak-current mode control during the switch-on period T_{ON}. For example, as mentioned before, the current measurement circuit 214 may be implemented with a current sensor, such as a resistor connected in series with the switch SW.

In the example considered, a regulator circuit 2110 of the control circuit 210 is configured to generate a switch-off signal S_OFF as a function of the feedback signal FB and optionally the current sense signal CS (in case PCM is used). Such regulator circuits 2110 are well known in the art.

Conversely, for switching on the electronic switch SW, the control circuit 210 comprises a valley detection circuit 2100 configured to analyze the signal DMG provided by the valley monitoring circuit 216 and vary a signal T_{ZCD} in response to determining that the signal DMG indicates a valley in the voltage V_{DS}, e.g., by generating a pulse/trigger in the signal T_{ZCD}. For example, in the example considered, the valley detection circuit 2100 comprises a comparator 2102 configured to compare the signal DMG with a reference signal REF, which usually is close to 0 V, wherein the output of the comparator 2102 is asserted when the signal DMG falls below the value of the reference signal REF, and an edge detector (ED) 2104, e.g., configured to generate a pulse in the signal T_{ZCD} when the signal at the output of the comparator 2102 changes from de-asserted to asserted, e.g., in response to a rising edge of the signal at the output of the comparator 2102.

Accordingly, when switching at the first valley (instant t₃) the signal T_{ZCD} may be used as a switch-on signal S_ON. Conversely, in order to implement a control of a minimum switching frequency f_{SW}, the control circuit 210 shown in FIG. 5 comprises also a blanking circuit 2140 configured to generate a signal BLANK used to enable the valley detection circuit 2100 or mask the signal T_{ZCD}. For example, this is schematically shown via a logic gate 2120, such as a AND gate, configured to generate the signal SON indicating that the switch SW should be switched on as a function of the trigger signal T_{ZCD} and the signal BLANK, i.e., the signal BLANK masks the signal T_{ZCD}.

Accordingly, in the example considered, the control circuit 210 may be configured to generate the signal DRV as a function of the signals S_ON and S_OFF. For example, in FIG. 5, the signals S_ON and S_OFF are provided to a latch or flip-flop 2130, e.g., the set and reset input of a respective set-reset latch or flip-flop, and the signal at the output of the latch or flip-flop 2130 is used to generate the drive signal DRV, e.g., via an optional FET driver circuit 2132 configured to generate the drive signal DRV as a function of the signal at the output of the latch or flip-flop 2130.

Accordingly, in the example considered, the pulsed signal T_{ZCD} coming from the valley detection circuit 2100 is masked with the blanking circuit 2140 having a respective blank interval T_{BLANK}, which ensures that the switch SW remains opened at least until the interval T_{BLANK} ends. In this way, when one or more pulses of the trigger signal T_{ZCD} is within the T_{BLANK} window, the switch-on of the switch SW is delayed until the first valley occurs after the time T_{BLANK} has elapsed, thereby limiting the maximum value of the switching operating frequency. This function is sometimes referred to as “valley-skipping.” In general, the blanking time T_{BLANK} may be either fixed or variable. For example, in some commercially available control circuits 210 (implemented in a respective IC), the blanking time T_{BLANK} is variable as function of the feedback level FB to gradually decrease the operating frequency f_{SW} with the load. Alternatively, may be used the current sense signal CS, because with a lower load, also the (peak value of the) signal CS is smaller.

For example, in known solutions, more and more ringing cycles are skipped and the operating frequency gradually decays. For example, based on the load conditions (and/or the input power), the control circuit 210 may operate the electronic converter 20 with the following modes: in response to determining that the input or output power exceeds a first value, a quasi-resonant mode, wherein the switch SW is switched on with the first valley; in response to determining that the input or output power is smaller than the first value, a valley skipping mode, wherein one or more of the valleys are skipped in order to limit the switching frequency f_{SW}, and in response to determining that the input or output power is smaller than a second value (which is smaller than the first value), optionally with a burst mode, wherein the control circuit generates one or more switching cycles, e.g., until the output voltage Vₒᵤₜ exceeds a given upper threshold, and then waits until the output voltage Vₒᵤₜ falls below a given lower threshold.

However, a sequence of switching cycles may be unregular when the blanking time T_{BLANK} ends near one of the valleys, because in this case the control circuit 210 may switch during a cycle at a given valley i and during the following cycle at the valley i−1, and vice versa. This “valley-jump” phenomenon may introduce a low-frequency component in the current flowing through the electronic switch SW that may fall in the audible range. If this periodic perturbation is sufficiently large in amplitude, audible noise may be generated, e.g., by mechanical vibrations of the magnetic components.

Various control circuits are known which address this valley-jump issue. For example, various control circuits 210 comprise a counter configured to count the number of triggers in the signal T_{ZCD} and the control circuit 210 is configured to determine a number of valleys to be skipped. For example, such as solution is disclosed in U.S. Pat. No. 11,482,935 B1 (incorporated herein by reference).

However, as shown in FIG. 6, usually the amplitude of the oscillation of the voltage V_{DS} at the electronic switch SW decreases. For this reason, the valley monitoring circuit 216 and/or the valley detection circuit 2100 may be unable to detect one or more of the valleys in the voltage V_{DS}. For example, in FIG. 6, the signal T_{ZCD} comprises a pulse at a first valley at an instant t₃, a second valley at an instant t₃′, and a third valley at an instant t₃″. However, the signal T_{ZCD} does not comprise a pulse for the fourth valley at an instant t₃′″. Accordingly, in case the control circuit 210 would be configured to skip the first three valleys, e.g., via a masking via a blanking timer 2140 or an explicit counting of the pulses in the signal T_{ZCD}, the control circuit 210 would be unable to generate correctly the switch-on signal SON.

For this reason, the control circuit 210 may comprise a (time-out or watchdog) timer circuit (T) 2150 configured to generate a time-out signal TO indicating whether a maximum time Tₘₐₓ has lapsed. For example, the maximum time Tₘₐₓ may refer to the time T₃ (as shown in FIG. 6), the time T_{OFF} or even the time T_{SW}, i.e., the timer circuit 2150 may be reset at the instant t₀, t₁ or t₂. Accordingly, in response to determining that the time-out signal TO indicates a time-out condition, the control circuit 210 may be configured to assert the signal S_ON, as schematically shown via a logic gate 2152, such as an OR gate, configured to generate the signal SON by combining the signal from the valley detector 2100, e.g., at the output of the logic gate 2120, and the time-out signal TO.

However, in this way, the time T₂ may be significantly greater than an expected minimum blanking time T_{BLANK}, which also negatively influences the performance of the electronic converter.

Concerning the operation of electronic converters, reference may be made, e.g., to United States Patent Application Publications Nos. 2022/0352815 A1, 2019/0181765 A1, 2023/0188045 A1, 2020/0412232 A1, 2016/0294291 A1 and 2019/0044432 A1 (all of which are incorporated herein by reference).

There is accordingly a need in the art to provide improved solutions for quasi-resonant control circuits.

### SUMMARY

According to one or more embodiments, concern a control circuit. Embodiments moreover concern a related integrated circuit, electronic converter and method.

Various embodiments of the present disclosure relate to a control circuit for a quasi-resonant electronic converter comprising an electronic switch. In various embodiments, the control circuit, e.g., integrated in an integrated circuit, comprises a regulator circuit configured to generate a switch-off signal as a function of a feedback signal indicative of an output voltage or an output current provided by the electronic converter, and a valley detection circuit configured to generate a valley signal indicating valleys in a voltage at the electronic switch, wherein the control circuit is configured to generate a switch-on signal as a function of the valley signal. A driver circuit is configured to generate a drive signal for the electronic switch as a function of the switch-on signal and the switch-off signal.

Specifically, in various embodiments, the control circuit comprises a valley selection circuit configured to generate a valley selection signal indicative of a requested number of valleys, a timeout timer circuit, a counter circuit and a comparison circuit.

Specifically, in various embodiments, the timeout timer circuit is configured to determine whether a first time has lapsed with respect to a last instant when the valley signal indicates a valley in a voltage at the electronic switch. In response to determining that the first time has lapsed, the timeout timer circuit generates periodically pulses in a time-out signal, wherein the pulses are repeated with a second time, wherein the second time is smaller than the first time, whereby the time-out signal comprises a first pulse after the first time and then following pulses spaced by the second time. In various embodiments, the first time is at least three times the second time.

For example, in various embodiments, the timeout timer circuit comprises a timer circuit configured to monitor a reset signal indicating a reset event and generate an end signal in response to determining that a given time has lapsed with respect to a last reset event. In this case, the timer circuit may be configured to signal a reset event via the reset signal in response to determine that the valley signal indicates a valley in a voltage at the electronic switch or the given time has lapsed with respect to a last reset event. Accordingly, in various embodiments, the timer circuit is configured to determine whether the given time has lapsed at least once. In response to determining that the given time has not lapsed at least once, the timer circuit uses the first time as the given time. Conversely, in response to determining that the given time has lapsed at least once, the timer circuit uses the second time as the given time.

For example, in various embodiments, the timer circuit comprises a current source providing a charge current to a node, a capacitance connected to the node, an electronic switch connected in parallel to the capacitance and configured to be closed in response to the reset signal, and a comparator configured to compare the voltage at the capacitance with a reference voltage. In this case, at least one of the charge current, the capacitance and the reference voltage may be switchable between a respective first value associated with the first time and a respective second value associated with the second time.

Alternatively, in various embodiments, the timeout timer circuit comprises a counter circuit configured to increase a count value in response to the end signal and determine whether the given time has lapsed at least once. In response to determining that the given time has not lapsed at least once, the counter circuit of the timeout timer circuit compares the count value with a first threshold, and in response to determining that the count value has reached or exceeds a first threshold, the counter circuit generates a pulse in the time-out signal. Conversely, in response to determining that the given time has lapsed at least once, the counter circuit of the timeout timer circuit compares the count value with a second threshold, and in response to determining that the count value has reached or exceeds a second threshold, the counter circuit generates a pulse in the time-out signal, wherein the second threshold is smaller than the first threshold.

In various embodiments, the counter circuit of the control circuit is configured to determine whether the valley signal indicates a valley in the voltage at the electronic switch and whether the time-out signal comprises a pulse. In response to determining that the valley signal indicates a valley in the voltage at the electronic switch or the time-out signal comprises a pulse, the counter circuit increases a valley count signal. For example, in various embodiments, the counter circuit comprises a logic gate configured to generate a modified valley signal by combining the valley signal with the time-out signal, and a valley counter circuit configured to increase the valley count signal in response to the modified valley signal.

In various embodiments, the comparison circuit is configured to assert the switch-on signal in response to determining that the valley count signal corresponds to or is greater than the requested number of valleys. Accordingly, in various embodiments, the switch-on signal is asserted, once the comparison circuit signals that a given number of valleys has been reached, wherein the counter circuit increases the valley count signal in response to the valley signal and the time-out signal, which signals “virtual pulses” once the valley signal fails to signal valleys. Specifically, for this purpose, the time-out circuit uses a first time-threshold for the first pulse, and then a second time-threshold for the following pulses.

### BRIEF DESCRIPTION OF THE DRAWINGS

Embodiments of the present disclosure will now be described with reference to the annexed drawings, which are provided purely by way of non-limiting example and in which:

FIG. 1 shows an example of an electronic converter, such as a PFC boost converter;

FIG. 2 shows exemplary waveforms of a driving scheme with valley switching for the electronic converter of FIG. 1;

FIGS. 3A and 3B shows examples of valley monitoring circuits for the electronic converter of FIG. 1;

FIG. 4 shows exemplary waveforms of a driving scheme with valley skipping for the electronic converter of FIG. 1;

FIG. 5 shows an example of a control circuit for a quasi-resonant electronic converter, such as the converter of FIG. 1;

FIG. 6 shows exemplary waveforms of a driving scheme with a maximum time-out condition for the electronic converter of FIG. 1;

FIG. 7 shows an embodiment of a control circuit for a quasi-resonant electronic converter;

FIG. 8 shows exemplary waveforms of a driving scheme with virtual valley pulses;

FIGS. 9 and 10 show further examples of the voltage at the electronic switch of the electronic converter;

FIGS. 11A and 11B show a comparison between a driving scheme with valley skipping and a driving scheme with virtual valley pulses;

FIG. 12 shows exemplary waveforms of a further driving scheme with virtual valley pulses;

FIG. 13 shows an embodiment of a timer circuit for the control circuit of FIG. 7;

FIG. 14 shows an embodiment of a logic circuit of the timer circuit of FIG. 13;

FIG. 15 shows an embodiment of a further valley monitoring circuit;

FIG. 16 shows exemplary waveforms with the valley monitoring circuit of FIG. 15;

FIG. 17 shows exemplary waveforms for the timer circuit of FIG. 13 and the logic circuit of FIG. 14; and

FIG. 18 shows an embodiment of a Finite-State Machine of the logic circuit of FIG. 14.

### DETAILED DESCRIPTION

In the following description, numerous specific details are given to provide a thorough understanding of embodiments. The embodiments can be practiced without one or several specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The references provided herein are for convenience only and do not interpret the scope or meaning of the embodiments.

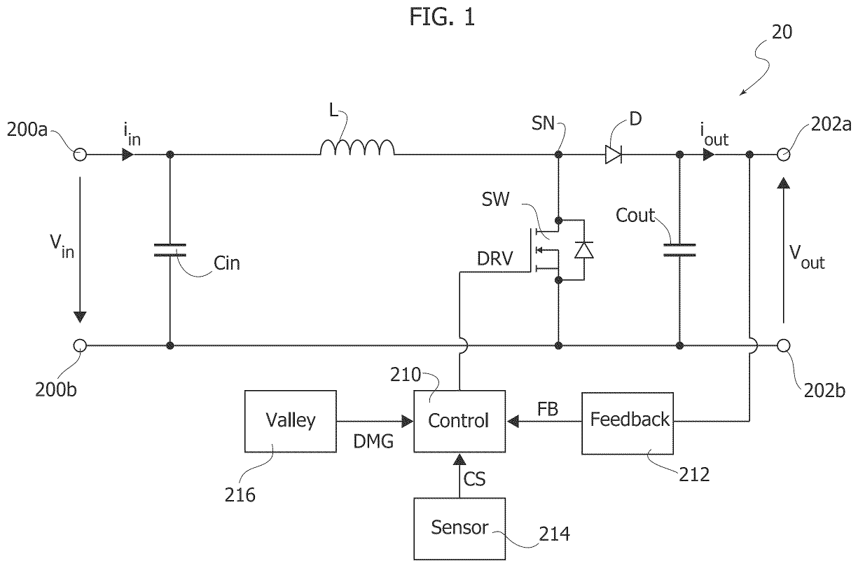

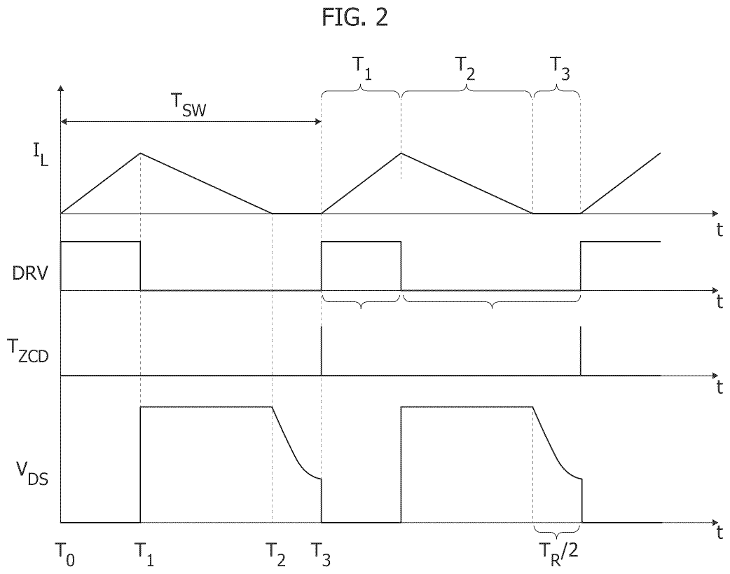

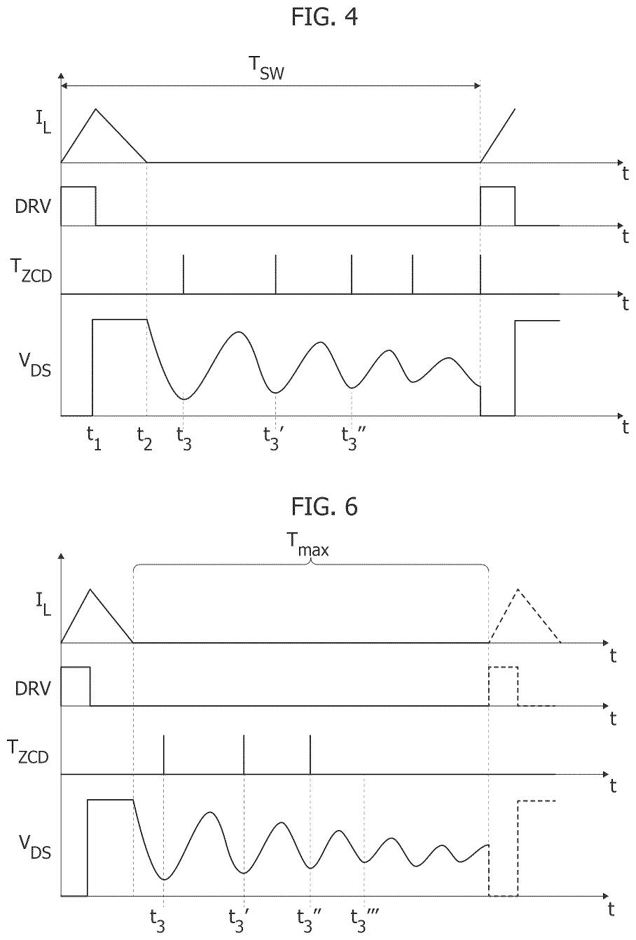

In the following FIGS. 7 to 18 parts, elements or components which have already been described with reference to FIGS. 1 to 6 are denoted by the same references previously used in such Figure; the description of such previously described elements will not be repeated in the following in order not to overburden the present detailed description.

As mentioned before, various embodiments of the present disclosure relate to a control circuit for a quasi-resonant converter.

FIG. 7 shows an embodiment of a control circuit 210a for a quasi-resonant converter. For a general description of a quasi-resonant converter, such as a PFC boost converter, reference is made to the previous description of FIGS. 1 to 6.

Specifically, in the embodiment considered, the control circuit 210a, such as an integrated circuit, comprises two terminals for receiving a supply voltage, such as a (positive) terminal VDD and a ground terminal GND, and a terminal for providing a drive signal DRV to an electronic (power) switch SW of the electronic converter, such as the gate terminal of a respective n-channel FET, e.g., a NMOS. As mentioned before, the electronic switch SW is usually configured to connect a resonant circuit of the electronic converter to the input terminals 200a and 200b of the electronic converter. In various embodiments, the control circuit 210a may also comprises further terminals for generating further drive signals, e.g., in case the resonant circuit is connected to the input terminals 200a 200b via a half-bridge or full-bridge arrangement. Additionally, or alternatively, one or more switches may be used to connect the resonant circuit to the output terminals 202a and 202b of the electronic converter.

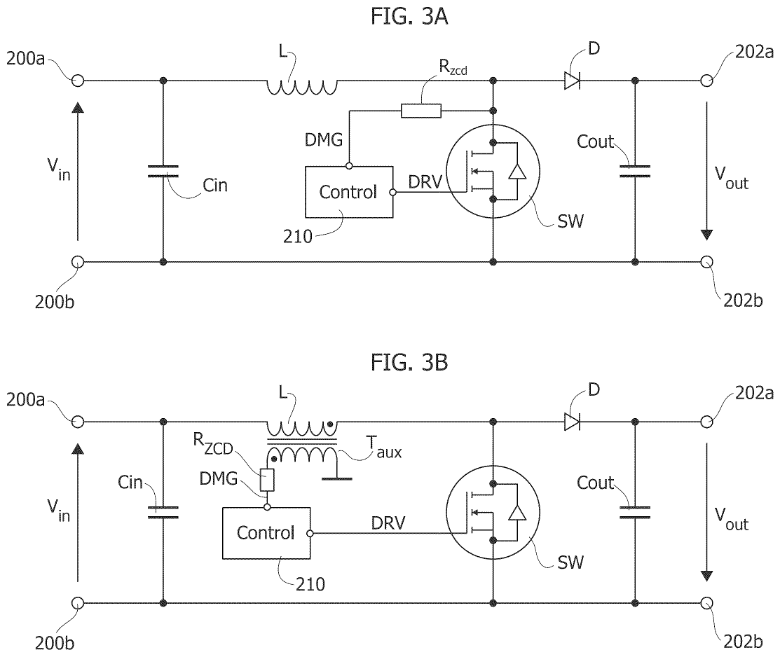

Moreover, the control circuit 210a comprises terminals for monitoring the operation of the electronic converter. Specifically, in the embodiment considered, a first terminal is configured to receive a feedback signal FB from a feedback circuit 212, wherein the feedback signal FB is indicative of the output quantity to be regulated, e.g., the output voltage Vₒᵤₜ or the output current iₒᵤₜ provided via output terminals 202a and 202b of the electronic converter. In various embodiments, the feedback signal FB corresponds directly to an error signal. A second terminal is configured to receive a signal DMG from a valley monitoring circuit 216, wherein the signal DMG is indicative of the voltage V_{DS} at the electronic switch SW (at least) during the period T₃. For example, the valley monitoring circuit 216 may monitor directly the voltage V_{DS} at the electronic switch SW, such as the drain-source voltage of a FET, or may monitor the valley implicitly by determining a demagnetization of the inductance of the resonant circuit (as described with respect to FIGS. 3A and 3B).

In various embodiments, a third terminal may be configured to receive a signal CS from a current measurement circuit 214, wherein the signal CS is indicative of (e.g., proportional to) the current flowing through the electronic switch SW (at least) during the switch-on period T_{ON}. As mentioned before, during the switch-on period T_{ON} the signal CS is usually indicative of the current provided to the resonant circuit, such as the current flowing through an inductance of the resonant circuit, such as the current I_{L} flowing through the inductance L. In fact, this permits to implement the peak-current mode control during the switch-on period T_{ON}. For example, as mentioned before, the current measurement circuit 214 may be implemented with a current sensor, such as a resistor connected in series with the switch SW.

In the embodiment considered, a regulator circuit 2110 of the control circuit 210a is configured to generate a switch-off signal S_OFF as a function of the feedback signal FB and optionally the current sense signal CS (in case PCM is used).

Conversely, for switching on the electronic switch SW, the control circuit 210a comprises a valley detection circuit(VD) 2100 configured to analyze the signal DMG provided by the valley monitoring circuit 216 and generate a signal T_{ZCD} indicating a valley in the voltage V_{DS}. For example, the valley detection circuit 2100 may generate a trigger/pulse in the signal T_{ZCD} in response to determining that the signal DMG indicates a valley in the voltage V_{DS}. In various embodiments, the valley monitoring circuit 216 and the valley detection circuit 2100 may also be combined, and may be internal or external with respect to an integrated circuit comprising the other components of the control circuit 210a. For example, the control circuit 210a may receive via the terminal DMG directly a trigger signal T_{ZCD}.

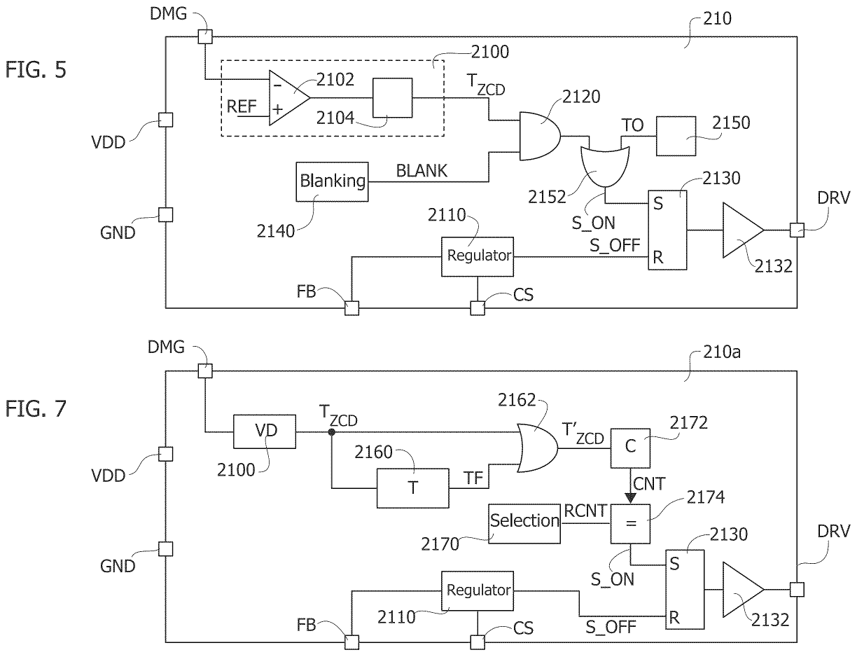

As described with respect to FIGS. 5 and 6, in such an arrangement, the valley detector 2100 may sometimes not signal correctly a valley in the voltage V_{DS}. For example, the amplitude of the oscillation decreases with time, and this decrease depends on the parasitic resistances, whereby the resonant circuit is rather a LCR network. For this reason, the control circuit shown in FIG. 5 was configured to monitor (see, circuit 2150) a maximum time Tₘₐₓ for the interval T₃, T_{OFF} or T_{SW}.

Conversely, in the embodiment considered, the control circuit 210a comprises a (time-out or watchdog) timer circuit (T) 2160 configured to generate a time-out signal TF indicating whether a maximum time T_{f} has lapsed. Specifically, in the embodiment considered, the timer circuit 2160 is configured to generate a pulse in the signal TF in response to determining that the maximum time T_{f} has lapsed with respect to the last pulse in the signal T_{ZCD}, e.g., the timer circuit 2160 is configured to be reset in response to the trigger signal T_{ZCD}. Moreover, in various embodiments, the timer circuit 2160 is configured to generate a pulse in the signal TF in response to determining that the maximum time T_{f} has lapsed with respect to the last pulse in the signal TF, e.g., the timer circuit 2160 is configured to be reset when the signal TF is asserted.

Accordingly, in the embodiment considered, the timer circuit 2160 generates “virtual pulses” when the signal T_{ZCD} ceases to signal valleys via the signal T_{ZCD}. For this reason, in the embodiment considered, the control circuit 210a is configured to generate a signal T′_{ZCD} by combining the signals T_{ZCD} and TF. Accordingly, the switch-on signal SON could be generated by combining the signal T′_{ZCD} with a blanking signal BLANK provided by a blanking timer 2140 (see also the description of FIG. 5).

Conversely, in the embodiment considered, the blanking circuit 2140 is replaced with a valley selection circuit 2170 configured to provide a signal RCNT indicative of a requested number of valleys. Accordingly, instead of monitoring a blanking time T_{BLANK}, the circuit 2172 directly provides the index of the valley at which the control circuit 210a should close the electronic switch SW. For example, this permits to avoid the previously described valley jump phenomena.

Specifically, in the embodiment considered, the signal T′ZC_{D} is provided to a valley counter circuit (C) 2172 is configured to generate a count value CNT by counting the valleys in each switching period T_{SW}. For example, in various embodiments, the counter 2172 is reset at the beginning of the interval T_{SW}, T_{OFF} or T₃, and counts the pulses in the signal T′ZCD. Accordingly, in the embodiment considered, the count signal CNT and the valley selection/reference signal RCNT are provided to a comparator (=) 2174 configured to assert the signal SON in response to determining that the count value CNT corresponds to the valley selection/reference signal RCNT. In various embodiments, the signal RCNT may also indicate the valleys to be skipped. In this case, the comparator 2174 is configured to assert the signal S_ON in response to determining that the count value CNT is greater than the reference signal RCNT.

Accordingly, in the embodiment considered, the control circuit 210a closes the electronic switch SW after a given number of valleys in the signal V_{DS}, as indicated via the signal RCNT. In various embodiments, similar to the blanking time T_{BLANK}, the valley selection circuit 2170 may vary the signal RCNT in order to ensure a minimum blanking time T_{BLANK}. Additionally, or alternatively, the valley selection circuit 2170 may vary the signal RCNT as a function of the input voltage Vᵢₙ and/or the output load.

For example, the valley selection circuit 2170 may be configured to indicate that the electronic switch SW should be closed at the first valley when the output load is greater than a given threshold. Conversely, when the load falls below the threshold, the valley selection circuit 2170 may be configured to increase the value RCNT when the load decreases. For example, in various embodiments, the valley selection circuit 2170 may be configured to vary the number of valleys to be skipped between 1 and 12.

Accordingly, in the embodiments considered, the control circuit 210a is configured to generate the drive signal DRV as a function of the signals S_ON and S_OFF. In the embodiment considered, the signals S_ON and S_OFF are provided to a latch or flip-flop 2130, e.g., the set and reset input of a respective set-reset latch or flip-flop, and the signal at the output of the latch or flip-flop 2130 is used to generate the drive signal DRV, e.g., via an optional FET driver circuit 2132 configured to generate the drive signal DRV as a function of the signal at the output of the latch or flip-flop 2130. In various embodiments, the circuit 2130 may also comprise a PWM signal modulator.

The various circuits/blocks shown in FIG. 7 may be implemented in any suitable way, e.g., via analog and/or digital circuits. For example, the timer circuit 2160 may be a digital timer circuit, e.g., comprising a digital counter, or an analog timer circuit, e.g., comprising a ramp generator and an analog comparator. In this respect, one or more of the circuits may be implemented via a microprocessor configured to execute software instructions.

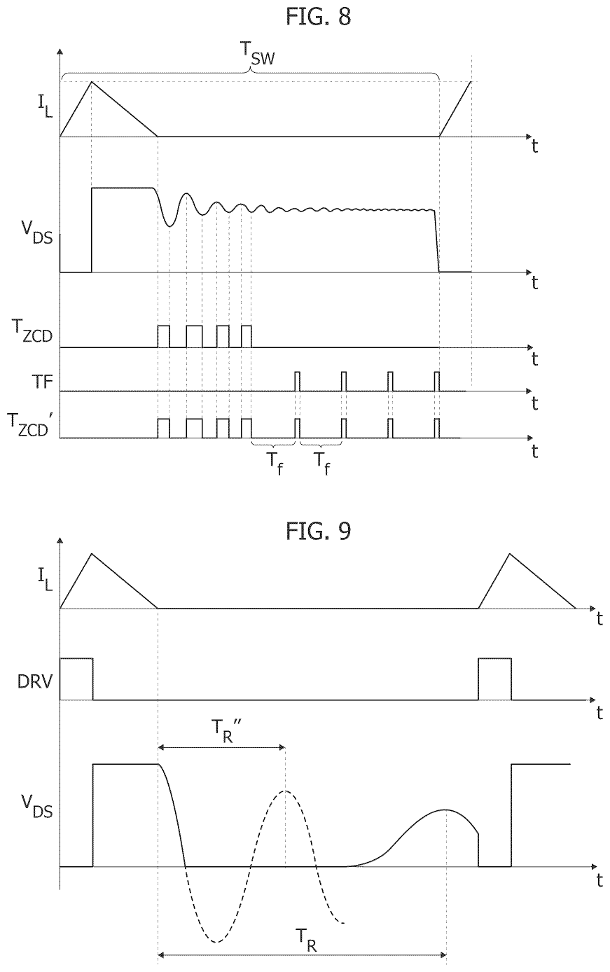

FIG. 8 shows an example, wherein the signal T_{ZCD} comprises four pulses, but the following pulses are not detected. Accordingly, in response to determining that the time T_{f} has lapsed with respect to the last pulse in the signal T_{ZCD}, the timer circuit 2160 generates a first pulse in the signal TF, and thus in the signal T′ZC_{D}. Moreover, since no further pulses are generated in the signal T_{ZCD}, the timer circuit 2160 continues to generate periodically pulses in the signal TF, wherein each pulse is generated once the timer circuit 2160 detects that the time T_{f} has lapsed with respect to the last pulse in the signal TF.

In the example shown in FIG. 8, the electronic switch SW is closed in response to the eighth pulse in the signal T′ZC_{D}. Accordingly, in the embodiment considered, the signal RCNT would indicate that the switch SW should be closed with the eighth pulse or that seven pulses should be skipped.

The solution described in the foregoing is particularly useful for low load conditions, where a significant number of valleys may be skipped. In fact, the amplitude of the oscillation of the voltage V_{DS} decreases with time, wherein the magnitude of the decrease depends on the parasitic resistance. In this way, the amplitude of the oscillation may fall below the minimum detectable voltage of the valley detection circuit 2100, whereby one or more valleys are not signaled.

In such conditions, the timer circuit 2160 generates additional triggers in the signal T′_{ZCD}, which ensure that the following circuits operate correctly, in particular because the valley counter circuit 2172 may still increase the respective count value CNT.

In the embodiment considered, the time T_{f} should thus have a value being greater than the maximum period T_{R} of the oscillation in the voltage V_{DS}, i.e., T_{f}≥T_{R,max}. However, as shown in FIG. 8, this implies that the time T_{f} may be significantly greater than the actual resonance period T_{R} and the switching time T_{SW} may become significantly greater than expected for a given valley selection signal RCNT. For example, in this way, the switching frequency f_{SW} may fall within the audible frequency range.

For example, as shown in equation (1), the period T_{R} depends on the application parameters, such as the inductance L and the capacitance (C_{OSS}+C_{d}), and can take different values based on the designed application. Accordingly, in principle, the value T_{f} could be set to the maximum possible period T_{R,max}. However, also the parameters of the converter may change during operation. For example, a power FET may be subject to a “C_{OSS} modulation”, where the output capacitance C_{OSS} increases significantly when the voltage V_{DS} is smaller than a given threshold value, wherein the threshold is typically in a range between 20V and 50V. This variation of the capacitance C_{OSS} implies that also the resonant period T_{R} varies as a function of the amplitude of the oscillations, e.g., whenever the voltage V_{DS} is smaller than the threshold value, the capacitance C_{OSS} increases and the period T_{R} increases. For example, as shown in FIG. 8, this may imply that the first oscillations have a greater period T_{R} than the subsequent ones.

Moreover, as shown in FIG. 9, when the amplitude of the oscillation is high, the voltage V_{DS} may also reach zero, and remain at zero due to the clamping effect of the body diode of the FET SW. For example, in a boost converter this is the case when the input voltage Vᵢₙ is smaller than Vₒᵤₜ/2, i.e., Vᵢₙ<Vₒᵤₜ/2. For example, in such a condition, the observable period T_{R} is usually significantly longer than the actual resonance period T_{R}* of the resonance circuit.

While these variations of the resonance period T_{R} may be observable in many quasi-resonant converters, the effect is particularly relevant in case of a PFC converter, because the input voltage Vᵢₙ essentially corresponds to positive sinusoidal half-waves, whereby the voltage Vᵢₙ varies significantly during each half-cycle.

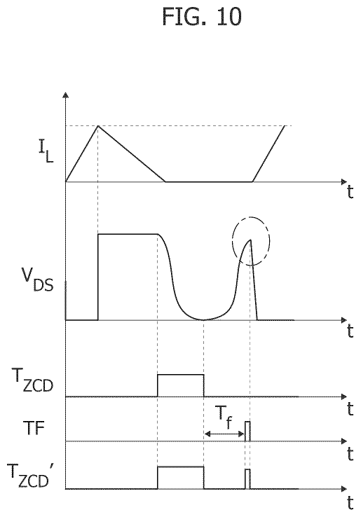

Conversely, as shown in FIG. 10, when the value T_{F} is smaller than the maximum T_{R,max}, the signal TF may comprise a trigger even when the voltage V_{DS} is still oscillating and the valley detector 2100 would indeed be able to detect the next valley. In such conditions, the signal TF may comprise a trigger even when the voltage V_{DS} has a peak value, thereby generating significant switching losses.

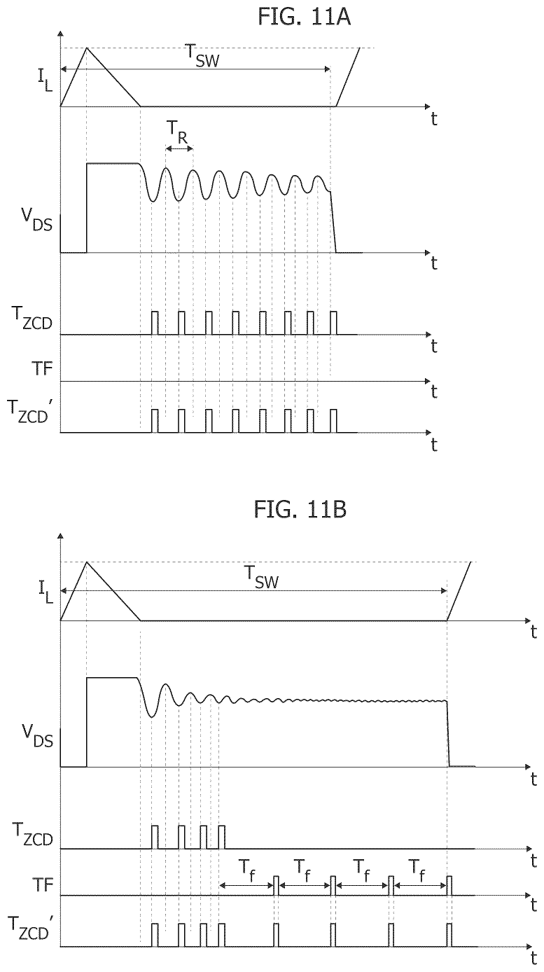

Accordingly, in order to avoid the above problems, the time T_{f} should be longer than the maximum period T_{R,max} of the first oscillation. However, as shown in FIGS. 11A-11B. in this case the time T_{SW} may become rather long when the number RCNT is high and the valley detector 2100 is unable to detect all valleys.

Specifically, FIG. 11A shows the case when the electronic switch SW should be closed with the eighth valley and the valley detector 2100 signals correctly the valleys of an oscillation have a period T_{R}.

Conversely, FIG. 11B shows the case when the electronic switch SW should be closed with the eighth valley and the valley detector 2100 is just able to detect the first four valleys and the following triggers are generated via the timer circuit 2160.

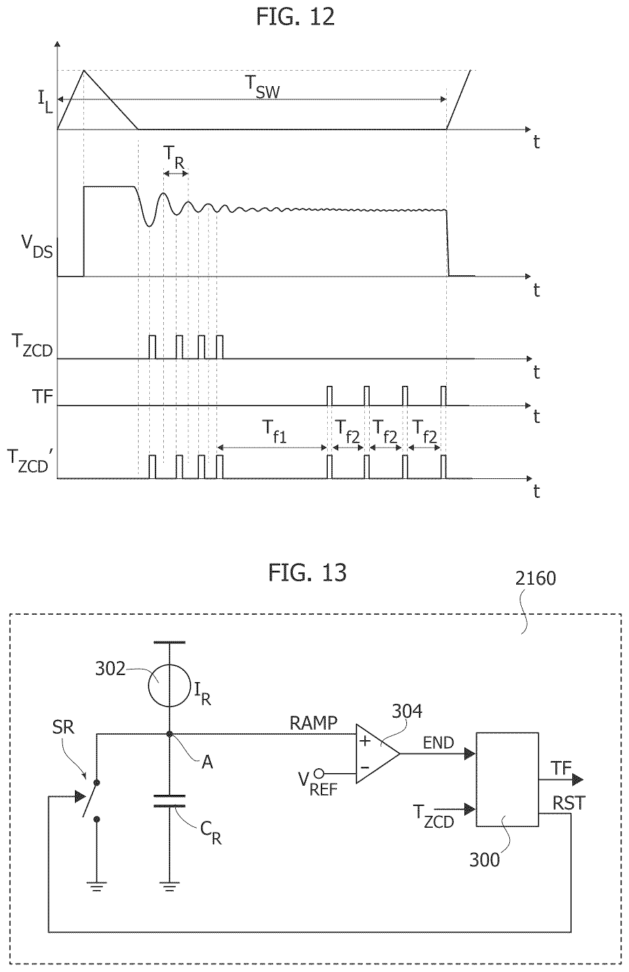

In the following will thus be described an improved control circuit 210a. Specifically, as shown in FIG. 12, in various embodiments, the timer circuit 2160 uses two different timeout values: a first timeout value T_{f1} for the first pulse in the signal TF, i.e., with respect to the last pulse in the signal T_{ZCD}; and a second timeout value T_{f2} for further pulses in the signal TF, i.e., with respect to the last pulse in the signal TF, wherein the second timeout value T_{f2} is smaller than the first timeout value T_{f1}.

For example, in various embodiments, the first timeout value T_{f1} has a duration that is fixed is at least three times a fixed duration of the second timeout value T_{f2}.

Specifically, in various embodiments, the first timeout value T_{f1} is greater than maximum period T_{R,max}. For example, in various embodiments, the first timeout value T_{f1} corresponds to c₁·T_{R}*, where T_{R}* corresponds to the expected resonance period of the resonant circuit, e.g., calculated according to equation (1), wherein the coefficient c₁ is greater than 1 and preferably greater then 2, e.g., selected in a range between 3 and 10. For example, in this way, the first pulse in the signal TF is only generated when the valley detection circuit 2100 is indeed unable to detect further valleys, even when the oscillation of the voltage V_{DS} reaches zero (see also the description of FIG. 10).

Conversely, the second timeout value T_{f2} is smaller than the first timeout value Tn. For example, in various embodiments, the second timeout value T_{f2} is selected in a range between c₂·T_{R}* and c₃·T_{R}*, with c₃>c₂, where the coefficient c₂ may be between 0.8 and 1.5 and/or the coefficient c₃ may be between 1.2 and 5.

For example, in FIG. 12, the valley detector circuit 2100 detects again just the first four valleys, which approximately have the same resonance period T_{R}. Accordingly, in response to determining that the time T_{f1} has lapsed with respect to the last pulse in the signal T_{ZCD}, the timer circuit 2160 generates a pulse in the signal TF, and thus in the signal T′ZC_{D}. As mentioned before, the time T_{f1} is (preferably significantly) greater than the resonance period T_{R}.

Accordingly, once having generated a first pulse in the signal TF, the timer circuit 2160 uses the second time T_{f2}, and generates a pulse in the signal TF each time the time T_{f2} has lapsed with respect to the last pulse in the signal TF.

As mentioned before, the timer circuit 2160 may be implemented in any suitable manner. For example, FIG. 13 shows a timer circuit comprising an analog ramp generator. In the embodiment considered, the ramp generator is implemented with a capacitance CR, a current source 302 and a reset switch SR.

Specifically, in the embodiment considered, the capacitance C_{R} is connected between a node A and ground, the current source 302 is configured to supply a current IR to the node A, and the electronic switch S_{R} is connected in parallel to the capacitance C_{R}. Accordingly, when the electronic switch S_{R} is opened, the current IR charges the capacitance C_{R} and the voltage at the node A increases. Conversely, when the electronic switch S_{R} is closed, the voltage at the node A is zero. Accordingly, in the embodiment considered, the electronic switch SR is closed in response to a reset signal RST and the voltage at the node A, i.e., the voltage at the capacitance CR, corresponds to a ramp signal RAMP.

In the embodiment considered, the ramp signal RAMP is provided to a comparator configured to generate an end signal END when the ramp signal RAMP reaches (or exceeds) a reference voltage VREF. Accordingly, the end signal END is asserted after a given time, which depends on the values of the current IR, the capacitance C_{R} and the reference voltage VREF.

In the embodiment considered, the end signal END and the signal T_{ZCD} are provided to logic circuit 300 configured to generate the time-out signal TF and the reset signal RST.

Specifically, in various embodiments, the logic circuit 300 is configured to assert the reset signal RST in response to determining that the signal END signals the timer circuit 2160 has reached the time T_{f}. For example, in various embodiments, this condition is signaled when the signal END changes its logic level from de-asserted to asserted. Moreover, the logic circuit 300 is configured to assert the reset signal RST in response to determining that the signal T_{ZCD} signals a valley in the voltage V_{DS}. The specific signaling depends on the properties of the signal T_{ZCD}. For example, in various embodiments, the instant of a valley is signaled via a rising or falling edge of the signal T_{ZCD}.

Conversely, in the embodiment considered, the signal TF should be asserted when the signal END signals that the timer circuit 2160 has reached the time T_{f}. For example, the signal TF may correspond to the end signal END or the logic circuit 300 may be configured to generate a pulse in the signal TF in response to the signal END, e.g., in response to determining that the signal END is asserted or in response to determining that the signal END changes its logic level from de-asserted to asserted.

Accordingly, in various embodiments, in order to implement different times T_{f1} and T_{f2}, the timer circuit 2160 is configured to change at least one of the values of the current IR, the capacitance C_{R} and the reference voltage V_{REF}, once a first trigger has been generated in the signal TF. For example, in a first embodiments, the current source 302 is configured to provide a first current I_{R1} associated with the time T_{f1} or a second current I_{R2} associated with the time T_{f2}, wherein the second current I_{R2} is greater than the first current I_{R1}. Conversely, in a second embodiments, the capacitance C_{R} is implemented with two capacitances, wherein at least one of the capacitances has associated an electronic switch in order to connect the respective capacitance between the node A and ground, thereby varying the capacitance C_{R} at the node A between a first value C_{R1} associated with the time T_{f1} and a second value C_{R2} associated with the time T_{f2}, wherein the second capacitance C_{R2} is smaller than the first capacitance C_{R1}.

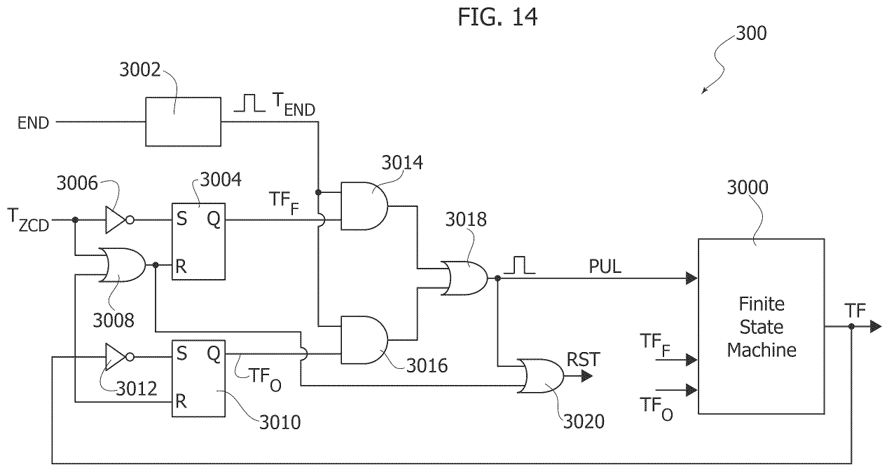

Conversely, FIG. 14 shows an alternative embodiment, wherein the logic circuit 300 uses the end signal END rather as a clock signal having a given base time T_{base}, and the logic circuit 300 comprises a Finite-State Machine (FSM) 3000 arranged to count pulses in the end signal END.

As mentioned before, in the embodiment considered, the end signal END is asserted once a time T_{base} lapses with respect to the last reset of the capacitance C_{R} via the reset signal RST. In the embodiment considered, the end signal END is provided to a pulse generator circuit 3002 configured to generate a trigger signal T_{END} comprising a pulse in response to determine that the end signal signals the end of the base time T_{base}. In various embodiments, the trigger signal T_{END} may also correspond directly to the end signal END, i.e., the pulse generator 3002 is purely optional.

In the embodiment considered, the logic circuit 300 is configured to count the pulses in the signal T_{END} until the signal T_{ZCD} signals a valley or the number of pulses reaches a threshold value, wherein the threshold value is indicative for the time T_{f1} or T_{f2}, based on whether the pulse to be generated in the signal TF is a first pulse of a following pulse.

For example, in various embodiments, the signal T_{ZCD} comprises a falling edge in order to indicate a valley. For example, a valley monitoring circuit configured to generate such a signal T_{ZCD} is shown in FIG. 15. Specifically, in the embodiment considered, the electronic converter 20 comprises a capacitance Cgd connected between the switching node SN, e.g., the drain terminal of the FET SW, and the control terminal of the electronic switch SW, e.g., the gate terminal of the FET SW. For example, in various embodiments, the capacitance Cgd corresponds to the parasitic drain-gate capacitance of the FET SW. Accordingly, in the embodiment considered, the terminal DMG corresponds to the terminal DRV, and the valley monitoring circuit 216 corresponds to the capacitance Cgd. The capacitance Cgd may be internal or external with respect to an integrated circuit of the control circuit 210a. For example, in various embodiments, the capacitance Cgd and the electronic switch SW are integrated in the integrated circuit of the control circuit 210a.

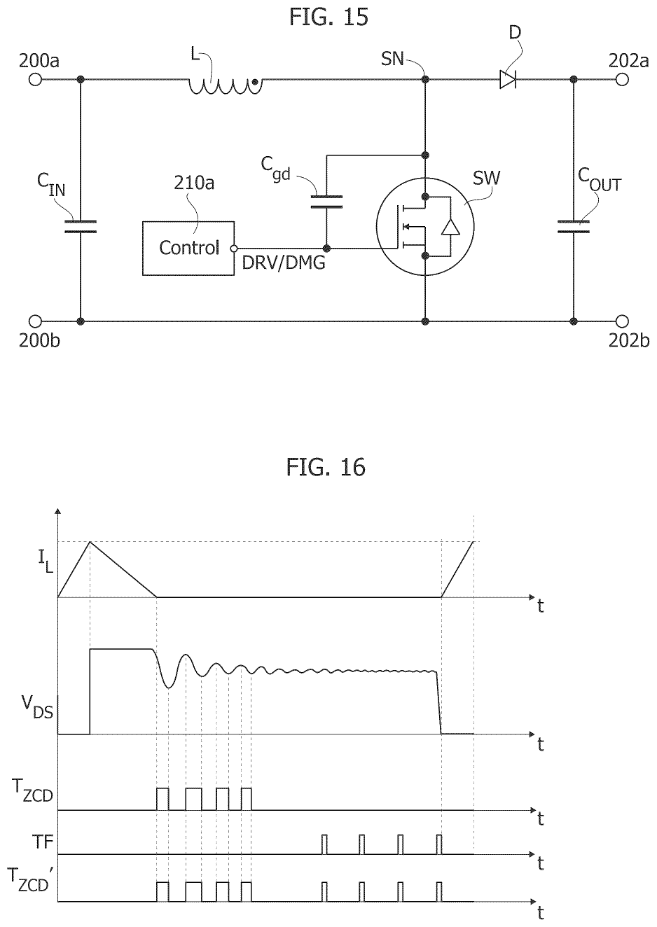

In this respect, in various embodiments, the valley detector circuit 2100 is configured to monitor the current provided via the terminal DRV/DMG. Specifically, as shown in FIG. 16, in various embodiments, the valley detector circuit 2100 is configured to assert the signal T_{ZCD}, in response to determining that the voltage V_{DS} decreases, i.e., when the capacitance Cgd discharges and a (positive) current is provided via the terminal DMG, which should be connected to ground during the interval T_{OFF}.

Accordingly, in the embodiment considered, the valley detector circuit 2100 is configured to assert the signal T_{ZCD} when the voltage V_{DS} decrease and de-assert the signal T_{ZCD} when the voltage V_{DS} increases, whereby a valley is signaled when the signal T_{ZCD} changes from asserted to de-asserted, e.g., with a falling edge of the signal T_{ZCD}.

Accordingly, in such situations, the logic circuit 300 is configured to detect a falling edge of the signal T_{ZCD}. However, in other embodiments, the logic circuit 300 may be configured to detect a rising edge of the signal T_{ZCD}.

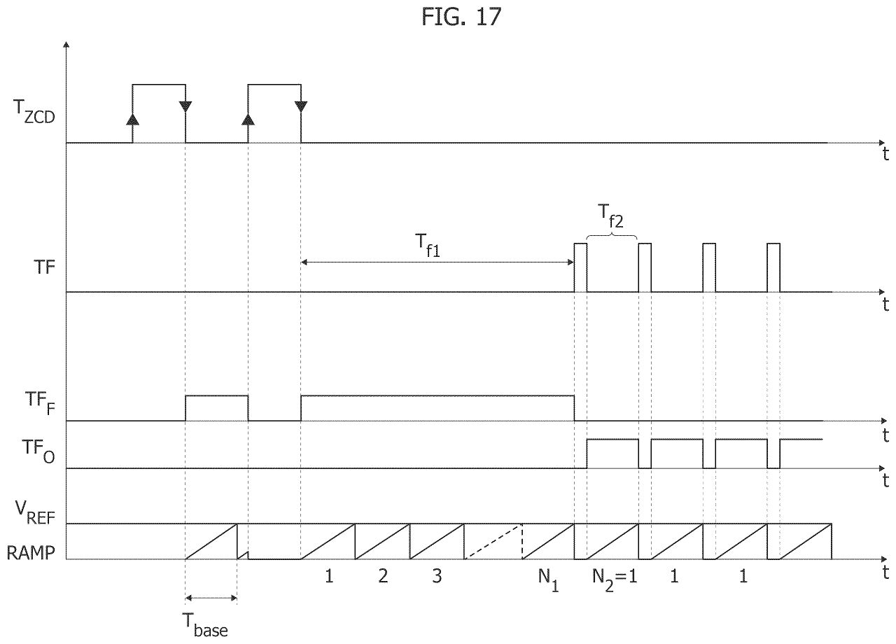

Specifically, in the embodiment considered and as also shown in FIG. 17, the logic circuit 300 is configured to assert a signal TF_{F} in response to determining that the signal T_{ZCD} is de-asserted. For example, in the embodiment considered, the logic circuit 300 comprises a set-reset latch or flip-flop 3004, wherein the set input receives the inverted version of the signal T_{ZCD}, as schematically shown via a logic inverter 3006. Accordingly, in the embodiment considered, the logic circuit 300 is configured to assert the signal TF_{F} in response to determining that the signal T_{ZCD} signals a valley in the voltage V_{DS}.

Conversely, in the embodiment considered, the logic circuit 300 is configured to de-assert the signal TF_{F} in response to determining that the signal T_{ZCD} is asserted. Specifically, in the embodiment shown in FIG. 16, the raising edge indicates that the voltage V_{DS} starts to decrease. However, the same operation may be used also with the signal T_{ZCD} shown in FIG. 12, wherein a rising edge of the pulse may signal a valley, and an immediately following falling edge signals that the timer circuit should monitor the time-out condition.

As shown in FIG. 17, in various embodiments, the logic circuit 300 is configured to de-assert the signal TF_{F} also in response to determining that the signal TF comprises a pulse, e.g., when the signal becomes asserted. For example, in the embodiment considered, the set-reset latch or flip-flop 3004 receives at the reset input the output signal of a logic OR gate 3008 receiving the signal T_{ZCD} and the signal TF.

Accordingly, in various embodiments the signal TF_{F} signals whether a first pulse should be generated in the signal TF. Additionally, or alternatively, the logic circuit 300 may be configured to generate a signal TFₒ indicating whether a further pulse should be generated in the signal TF. For example, in various embodiments, the logic circuit 300 is configured to assert the signal TFₒ in response to detecting a pulse in the signal TF, e.g., in response to detecting a rising or falling edge of the signal TF, or detecting that the signal TF is asserted.

For example, in the embodiment considered, the logic circuit 300 comprises a set-reset latch or flip-flop 3010 receiving at the set input the inverted version of the signal TF, as schematically shown via an inverter 3012, and at the reset input the signal TF. Accordingly, in various embodiments, the signal TFₒ is asserted in response to determining that the signal TF goes to low.

Accordingly, in various embodiments, the logic circuit 300 generates the signals RST and TF as a function of the signal T_{END}, and at least one of the signals TF_{F} and TFₒ.

For example, as shown in FIG. 17, in various embodiments, the logic circuit 300 is configured to assert the reset signal RST, thereby resetting the ramp signal RAMP (a) each time the signal T_{END} comprises a pulse, (b) each time the signal T_{ZCD} comprises a pulse, and (c) optionally each time the signal TF comprises a pulse. Specifically, condition (c) is optional, because conditional (a) could be sufficient.

Conversely, FIG. 14 shows a slightly different embodiment, wherein the logic circuit 300 is configured to generate a pulsed signal PUL, which comprises a pulse when the signal T_{END} comprises a pulse and at least one of the signals TF_{F} and TFₒ is asserted. For example, in the embodiment considered, the signal PUL is provided by an OR gate 3018 receiving at a first input the output signal of a first logic AND gate 3014 receiving the signals T_{END} and TF_{F}, and at a second input the output signal of a second logic AND gate 3016 receiving the signals T_{END} and TFₒ. Thus, in the embodiment considered, the logic circuit 300 generates the signal PUL by masking the pulses in the signal T_{END} as a function of the signals TF_{F} and TFₒ. Accordingly, in this case, condition (a) may be modified, and the logic circuit 300 may be configured to assert the reset signal RST each time the signal PUL comprises a pulse.

Conversely, conditions (b) and (c) may be verified by using the output signal of the OR gate 3008. Accordingly, in the embodiment considered, the logic circuit 300 comprises an OR gate configured to generate the reset signal RST by combing the signal PUL and the output signal of the OR gate 3008.

Accordingly, in the embodiment considered, the FSM 3000 is configured to generate the signal TF as a function of the signal T_{END} or PUL, and the signals TF_{F} and/or TFₒ. In general, the other blocks shown in FIG. 14 may also be implemented within the FSM 3000.

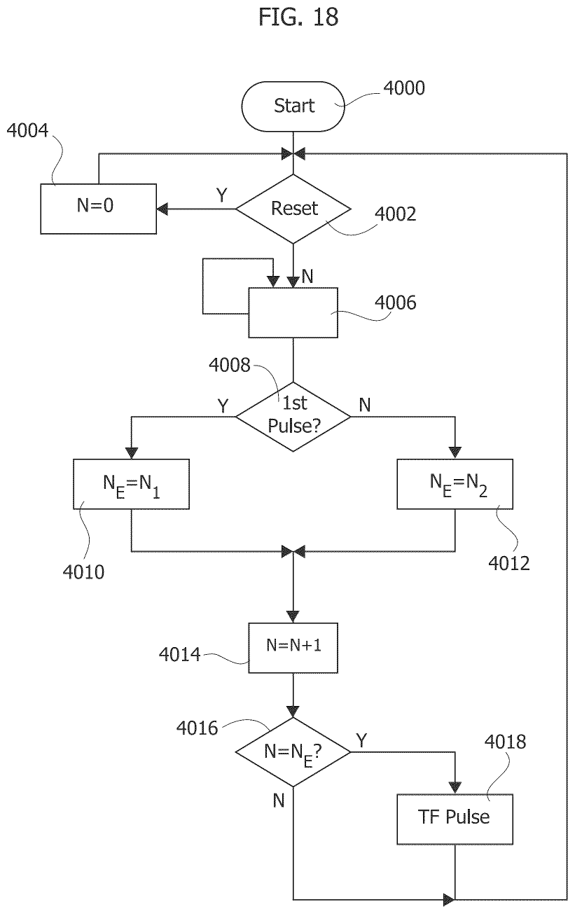

Specifically, as mentioned before, the FSM 3000 may be configured to count the pulses in the signal T_{END} or PUL, and generate a pulse in the signal TF when the number of pulses reaches a threshold, wherein the threshold corresponds to a first value N₁ for the first pulse, e.g., when the signal TF_{F} is asserted, and a second value N₂ for the further pulses in the same switching period T_{SW}, e.g., when the signal TF_{F} is de-asserted or the signal TFₒ is asserted, wherein the threshold N₂ is smaller than the threshold N₁, whereby the first pulse in the signal TF is generated after a time T_{f1}=N₁·T_{base} and each further pulse in the signal TF is generated after a time T_{f2}=N₂·T_{base}. For example, in FIG. 18, the first threshold N₁ is greater than three, and the second threshold N₂ is one.

FIG. 18 shows an embodiment of the FSM 3000. Specifically, after a start step, the FSM 3000 verifies at a step 4002 a reset condition. For example, the FSM may detect a reset of the FSM, when the signal T_{ZCD} is asserted or comprises a rising edge. While the step 4002 is shown as a sequential operation, indeed the reset may be asynchronous. In response to detecting a reset (output “Y” of the verification step 4002), the FSM 3000 initializes a count value N, e.g., by setting the count value N to zero.

Conversely, in the absence of a reset (output “N” of the verification step 4002), the FSM 3000 proceeds to a wait step 4006, where the FSM 3000 remains until the signal T_{END} or PUL comprises a pulse, e.g., by detecting a rising edge in the signal PUL, signaling that the time T_{base} has lapsed since the last reset of the ramp generator via the signal RST.

Next, the FSM 3000 verifies at a step 4008 whether the next pulse to be generated in the signal TF is the first pulse or a further pulse of a switching period T_{SW}, e.g., by using the signals TF_{F} and/or TFₒ. In response to determining that the next pulse is the first pulse of a switching period T_{SW} (output “Y” of the verification step 4008), the FSM uses as count threshold N_{E} the value N₁. Conversely, in response to determining that the next pulse is a further pulse of a switching period T_{SW} (output “N” of the verification step 4008), the FSM uses as count threshold N_{E} the value N₂.

Moreover, the FSM increases at a step 4014 the count value N by one. In general, the steps 4010, 4012 and 4014 may be executed in any sequence, possibly also in parallel.

In the embodiment considered, the FSM 3000 verifies then at a step 4016 whether the count value N has reached the threshold value N_{E}. In response to determining that the count N value has reached the threshold value N_{E} (output “Y” of the verification step 4016), the FSM 3000 generates at a step 4018 a pulse in the signal TF, and then returns to the step 4002. Conversely, in response to determining that the count N value has not reached the threshold value N_{E} (output “N” of the verification step 4016), the FSM 3000 returns to the step 4002, i.e., the FSM 3000 inhibits the generation of a pulse in the signal TF.

Accordingly, by using two different times T_{f1} and T_{f2}, the problems described with respect to FIGS. 8 to 11 may be avoided.

The scope of protection is defined in the enclosed claims, which are an integral part of the technical teaching of the disclosure provided herein.

Of course, without prejudice to the principle of the invention, the details of construction and the embodiments may vary widely with respect to what has been described and illustrated herein purely by way of example, without thereby departing from the scope of the present invention, as defined by the ensuing claims.

1. A control circuit for a quasi-resonant electronic converter including an electronic switch, said control circuit comprising:
a regulator circuit configured to generate a switch-off signal as a function of a feedback signal indicative of an output voltage or an output current provided by said quasi-resonant electronic converter;
a valley detection circuit configured to generate a valley signal indicating valleys in a voltage at said electronic switch, wherein said control circuit is configured to generate a switch-on signal as a function of said valley signal;
a driver circuit configured to generate a drive signal for said electronic switch as a function of said switch-on signal and said switch-off signal;
a valley selection circuit configured to generate a valley selection signal indicative of a requested number of valleys;
a timeout timer circuit configured to:
determine whether a first time has lapsed with respect to a last instant when said valley signal indicates a valley in a voltage at said electronic switch; and
in response to determining that said first time has lapsed, periodically generate pulses in a time-out signal, wherein said pulses are repeated with a second time, wherein said second time is smaller than said first time;
a counter circuit configured to:
determine whether said valley signal indicates a valley in said voltage at said electronic switch;
determine whether said time-out signal comprises a pulse; and
in response to determining that said valley signal indicates a valley in said voltage at said electronic switch or said time-out signal comprises a pulse, increase a valley count signal; and
a comparison circuit configured to assert said switch-on signal in response to determining that said valley count signal corresponds to or is greater than said requested number of valleys.

2. The control circuit according to claim 1, wherein said timeout timer circuit comprises a timer circuit configured to:
monitor a reset signal indicating a reset event; and
generate an end signal in response to determining that a given time has lapsed with respect to a last reset event.

3. The control circuit according to claim 2, wherein said timeout timer circuit is further configured to signal a reset event via said reset signal in response to determining that said valley signal indicates a valley in a voltage at said electronic switch or said given time has lapsed with respect to a last reset event.

4. The control circuit according to claim 3, wherein said timeout timer circuit is configured to:
determine whether said given time has lapsed at least once;
in response to determining that said given time has not lapsed at least once, use said first time as said given time; and
in response to determining that said given time has lapsed at least once, use the second time as said given time.

5. The control circuit according to claim 3, wherein said timeout timer circuit comprises:
a current source providing a charge current to a node;
a capacitance connected to said node;
an electronic switch connected in parallel to said capacitance and configured to be closed in response to said reset signal; and
a comparator configured to compare the voltage at said capacitance with a reference voltage.

6. The control circuit according to claim 5, wherein at least one of said charge current, said capacitance and said reference voltage is switchable between a respective first value associated with said first time and a respective second value associated with said second time.

7. The control circuit according to claim 3, wherein said timeout timer circuit comprises a further counter circuit configured to:
increase a count value in response to said end signal;
determine whether said given time has lapsed at least once;
in response to determining that said given time has not lapsed at least once, compare said count value with a first threshold, and in response to determining that said count value has reached or exceeds a first threshold, generate a pulse in said time-out signal; and
in response to determining that said given time has lapsed at least once, compare said count value with a second threshold, and in response to determining that said count value has reached or exceeds a second threshold, generate a pulse in said time-out signal, wherein said second threshold is smaller than said first threshold.

8. The control circuit according to claim 1, wherein said first time is at least three times said second time.

9. The control circuit according to claim 1, wherein said first time has a duration that is fixed and wherein said second time also has a duration that is fixed.

10. The control circuit according to claim 1, wherein said counter circuit comprises:
a logic gate configured to generate a modified valley signal by combining said valley signal with said time-out signal; and
a valley counter circuit configured to increase said valley count signal in response to said modified valley signal.

11. An integrated circuit, comprising the control circuit according to claim 1, wherein said integrated circuit comprises:
a first terminal configured to receive said feedback signal from a feedback circuit; and
a second terminal configured to connect said valley detection circuit to a valley monitoring circuit configured to monitor a signal indicative of the voltage at said electronic switch.

12. An electronic converter, comprising:
the control circuit according to claim 1;
two input terminals and two output terminals;
a resonant circuit;
an electronic switch configured to connect said resonant circuit to said two input terminals as a function of the drive signal provided by said control circuit;
a feedback circuit providing said feedback signal; and
a valley monitoring circuit configured to monitor a signal indicative of the voltage at said electronic switch.

13. The electronic converter according to claim 12, wherein said electronic converter is a boost converter, preferably a Power-Factor Correction boost converter.

14. A method of operating a quasi-resonant electronic converter including an electronic switch, the method comprising:
generating a switch-off signal as a function of a feedback signal indicative of an output voltage or an output current provided by said quasi-resonant electronic converter;
generating a valley signal indicating valleys in a voltage at said electronic switch;
generating a switch-on signal as a function of said valley signal;
generating a drive signal for said electronic switch as a function of said switch-on signal and said switch-off signal;
generating a valley selection signal indicative of a requested number of valleys;
determining whether a first time has lapsed with respect to a last instant when said valley signal indicates a valley in a voltage at said electronic switch, and in response to determining that said first time has lapsed, generating periodically pulses in a time-out signal, wherein said pulses a repeated with a second time, wherein said second time is smaller than said first time;
determining whether said valley signal indicates a valley in said voltage at said electronic switch, determining whether said time-out signal comprises a pulse, and in response to determining that said valley signal indicates a valley in said voltage at said electronic switch or said time-out signal comprises a pulse, increasing a valley count signal; and
asserting said switch-on signal in response to determining that said valley count signal corresponds to or is greater than said requested number of valleys.
